(19) United States
(12) Patent Application Publication
(10) Pub. No.: US 2018/0221829 A1
(43) Pub. Date: Aug. 9, 2018

(54) IN-SITU SOLAR-TO-HEAT COATING FOR DRINKING WATER PURIFICATION, SEAWATER DESALINATION, AND WASTEWATER TREATMENT

(71) Applicant: The Texas A&M University System, College Station, TX (US)

(72) Inventors: Zhengdong Cheng, College Station, TX (US); Yi-Hsien Yu, College Station, TX (US); Xiayun Huang, Shanghai (CN)

(21) Appl. No.: 15/888,055

(22) Filed: Feb. 4, 2018

Related U.S. Application Data
(60) Provisional application No. 62/454,761, filed on Feb. 4, 2017.

(51) Int. Cl. B01D 67/00; B05D 1/00; B05D 1/18; B01D 61/36; B01D 69/12; B01D 71/58; C02F 1/44

(52) U.S. Cl. CPC B01D 67/0088; B05D 1/60; B05D 1/18; B01D 61/364; B01D 67/0006; C02F 2103/08; B01D 71/58; C02F 1/447; B01D 2323/04; B01D 2311/2611; B01D 69/125

(57) ABSTRACT

An interfacial solar membrane includes a substrate with a coating of polypyrrole disposed on a surface of the substrate. The coating of polypyrrole is formed by dipping the substrate in a solution of pyrrole monomer and iron(III) chloride. The interfacial solar membrane can include a coating to improve a hydrophobicity of the interfacial solar membrane, such as a coating of 1H,1H,2H-perfluorooctyltriethoxysilane. A method of using the interfacial solar membrane includes using the interfacial solar membrane to evaporate a fluid and condensing the evaporated fluid to remove an impurity from the fluid.

### CROSS-REFERENCE TO RELATED APPLICATIONS

This application claims the benefit of priority to and incorporates by reference the entire disclosure of U.S. Provisional Patent Application No. 62/454,761 filed on Feb. 4, 2017.

### BACKGROUND OF THE INVENTION

The rapid growth of population, global warming, and environmental pollution have caused freshwater scarcity to be an increasing serious global challenge. 98% of the Earth's water supply requires desalination before it is drinkable. Many methods exist to purify water in order to remove impurities to make it drinkable, but these known methods require a large amount of energy. One of the more prominent technologies, reverse osmosis, requires a high amount of energy to maintain a high pressure in order to overcome the osmotic pressure of seawater (>55 bar). In nature, water sometimes evaporates as a result of heat from solar irradiation and subsequently condenses due to falling temperature. The concept of an evaporating/condensing process has been used in an attempt to perform thermal desalination. Early-stage thermal desalination techniques have tried heating seawater to evaporate the seawater and subsequently condensing the seawater to produce fresh water. However, these early attempts have not been efficient and a lot of thermal energy is wasted.

### SUMMARY OF THE INVENTION

To sufficiently convert solar energy to heat, an interfacial solar membrane is used to enhance a temperature of water at a water-air interface to efficiently convert the solar energy harvested by the interfacial solar membrane to quickly heat and evaporate the water at the water-air interface. In some embodiments, the interfacial solar membrane comprises polypyrrole coated polypropylene substrate that has achieved a conversion efficiency of approximately 70% and can be used to efficiently treat dirty water or seawater to make drinkable water.

A versatile dip-coating method was developed to fabricate hybrid coatings, such as polypyrrole (PPy), that match the spectrum of sunlight and effectively convert solar energy to heat for drinkable water purification, seawater desalination, and wastewater treatment. The PPy thin film can be tightly coated on a substrate of nonconductive polypropylene (PP) mesh to form an interfacial solar membrane. The PPy thin film can also be used to coat different types of substrates regardless of wetting property, conductivity, and surface curvature. High purity water can be collected from dirty water as well as saline water using this interfacial solar membrane desalination technique. Clean water is collected by evaporation of the dirty/saline water and recondensation of the evaporated water vapor. Water is evaporated via thermal energy from the interfacial solar membrane. In a typical embodiment, the thermal energy is supplied by the sun. The evaporated water subsequently condenses after the water vapor has cooled. The condensed water may be used as drinkable water, agricultural water, water for use by the petroleum industry, as well as other industries.

In some embodiments, an interfacial solar membrane comprises a polypyrrole coating was fabricated via a simple dip-coating method. A porous substrate, such as a polypropylene mesh, was dipped in a dilute aqueous solution of pyrrole monomer and iron(III) chloride. In situ polymerization of polypyrrole leads to a tight adhesion and a uniform coating with a thickness on each polypropylene fiber in the nanometer scale. In some embodiments a fluoroalkylsilane surface layer is covalently bonded to the polypyrrole coating, which helps to maintain a long-term hydrophobicity so that the interfacial solar membrane can float on a water-air interface to maintain a high water evaporation conversion efficiency. The water evaporation conversion efficiency, defined as the conversion efficiency from solar energy to heat of water evaporated, is 72%, which is slightly higher than stainless steel mesh with thick PPy coating with thickness in micro-meter scale and much higher than that of commercialized solar distilled system with typical efficiencies of 24-45%.

The advantages of PPy coating include: 1) a very thin coating of around 300 nanometers in thickness provides a high water evaporation conversion efficiency of around 72%; 2) interfacial solar membranes achieved high water evaporation conversion efficiency with low energy input and reduced carbon emission; 3) the instant dip-coating methods can be applied to various types of substrates, regardless of conductivity of the substrates, the curvature of substrates, and wettability of the substrates; 4) the solar-based in-situ heating can be used for other kinds of solution evaporation as well as heating source for other kinds of applications. This technique can be used in combination with evaporative cooling to further increase energy conversion efficiency. A further advantage includes reduced energy consumption for water treatment.

An embodiment of the invention is directed to a method of producing an in-situ solar-to-heat coating comprising: dipping a porous substrate into a dilute aqueous solution of pyrrole monomer and iron(III) chloride; allowing for in-situ polymerization of polypyrrole; and conducting chemical vapor silanization.

A further embodiment of the invention is directed to an in-situ solar-to-heat coating, wherein the coating comprises: polypyrrole coated on a substrate, 1H,1H,2H-perfluorooctyltriethoxysilane coated on the polypyrrole coating, wherein different types of substrates, regardless of their wetting property, conductivity, and surface curvature, may be used.

Another embodiment of the invention is directed to a method for water purification, the method comprising, allowing water to undergo evaporation and recondensation by receiving thermal energy from a coated substrate to evaporate water and subsequently condensing the evaporated water, wherein the condensing of evaporated water yields clean water.

Embodiments of the invention may be used, for example, for thermal desalination membranes using solar energy, as in-situ heating pipes and panels, as portable devices for drinkable water using the disclosed water purification methods, to improve water quality and people's living standards and health, in battle field applications for soldiers, for petroleum water treatment, agricultural water treatment, and sewage water treatment.

A method of the invention includes depositing a polypyrrole film coating on a substrate by solution based dipcoating. The solution includes water, dilute concentration of pyrrole, and iron (III) chloride. The polypyrrole thin film coating increases an in-situ temperature by solar irradiation and can be integrated into a water purification system and other systems that require localized heating.

### BRIEF DESCRIPTION OF THE DRAWINGS

A more complete understanding of embodiments of the present invention may be obtained by reference to the following Detailed Description when taken in conjunction with the accompanying Drawings wherein:

FIG. 1 illustrates growth of a polypyrrole (PPy) coating on a glass substrate with increased dipping time from 0.5 hours to 12 hours;

FIGS. 2A and 2B are graphs illustrating morphology of water wetting behavior and solar absorption of PPy coating where FIG. 2A illustrates absorption by the PPy coating matches the solar spectral irradiance and FIG. 2B illustrates water contact angle of hydrophilic PPy coating on glass with increasing dipping time from 0.5 hours to 12 hours;

FIGS. 3A and 3B are schematic illustrations of interfacial solar membranes for water evaporation; and

FIGS. 4A, 4B, 4C and 4D are graphs illustrating various aspects of a PPy coated mesh, where FIG. 4A illustrates photothermal heating and cooling of PP and PPy-coated PP mesh under 30 minutes of radiation, FIG. 4B illustrates solar evaporation of pure water, FIG. 4C illustrates solar evaporation of seawater (35,000 ppm NaCl), pure water, floating PP mesh, and floating PPy coated PP mesh, and FIG. 4D illustrates evaporation rate and solar vapor generation efficiency under different conditions (left to right: pure water, PP mesh floating on water, and PPy coated PP mesh floating on water, pure seawater, PP mesh floating on pure seawater, and PPy coated PP mesh floating on seawater, the light intensity was fixed at 1000 W/m², the area of the mesh is 861 mm²).

### DETAILED DESCRIPTION

Embodiment(s) of the invention will now be described more fully with reference to the accompanying Drawings. The invention may, however, be embodied in many different forms and should not be construed as limited to the embodiment(s) set forth herein. The invention should only be considered limited by the claims as they now exist and the equivalents thereof.

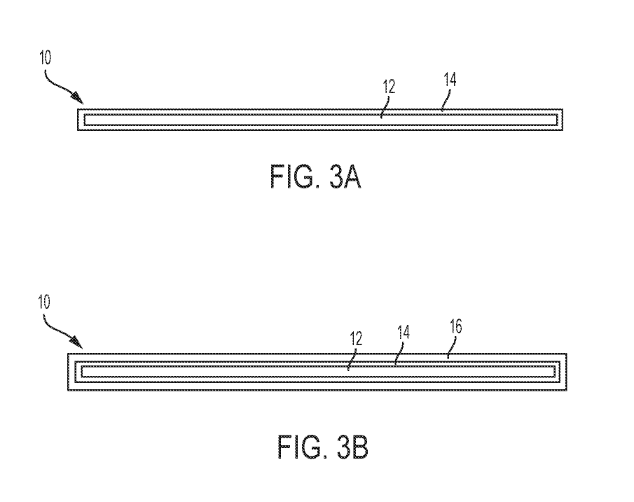

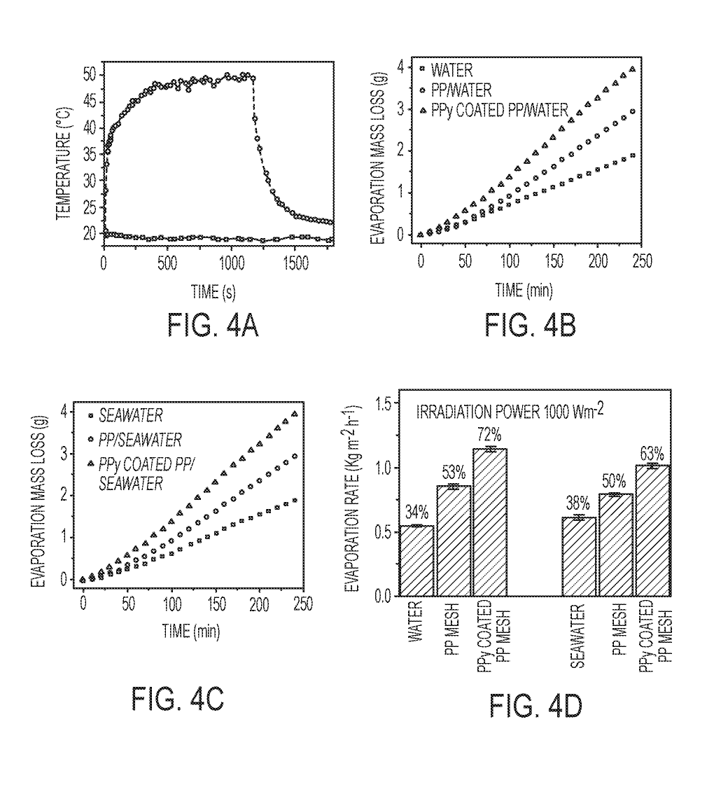

Embodiments of the claimed invention are directed to an in-situ solar-to-heat coating disposed on a substrate, wherein the coating comprises PPy. FIGS. 3A and 3B are schematic illustrations of an interfacial solar membrane 10 for water evaporation. The schematics of FIGS. 3A and 3B are sectioned side views of the interfacial solar membrane 10. As shown in FIG. 3A, the interfacial solar membrane 10 includes a substrate 12 and a coating 14. Different types of substrates 12, regardless of their wetting property, conductivity, and surface curvature, may be utilized. In a typical embodiment, the coating 14 comprises PPy. PPy coatings have been reported to have a good adhesion on a variety of substrates 12. The substrate 12 may comprise any of a variety of materials, such as metals, polymers, and ceramics as well as various shapes and curvatures, such as tubing, planar structures, and fibrous/mesh structures. In certain embodiments the substrate 12 may comprise a nonconductive material such as polypropylene. In other embodiments, the substrate 12 may comprise a conductive material, such as stainless steel. FIG. 3B illustrates a further embodiment of the interfacial solar membrane 10 that includes an additional coating 16. In some embodiments, the additional coating 16 comprises 1H,1H,2H-perfluorooctyltriethoxysilane that is coated over the coating 14. In some embodiments the silane coating is applied regardless of whether the substrate 12 is a conductive or a non-conductive material. In some embodiments the coating 14 is selected to match the spectrum of sunlight, wherein by matching the spectrum of sunlight solar energy that reaches the coating 14 is more easily converted to heat.

Another embodiment of the claimed invention is directed to a method of producing an in-situ solar-to-heat coating comprising: dipping a porous substrate into a dilute aqueous solution of pyrrole monomer and iron(III) chloride, wherein, in certain embodiments, the porous substrate is comprised of a polypropylene mesh; allowing adequate time to pass for in situ polymerization of polypyrrole, wherein in situ polymerization of polypyrrole leads to tight adhesion and uniform coatings with thickness in nanometer scale; and chemical vapor silanization wherein chemical vapor silanization causes all of the layers of the coating, including the surface layer and the polymer and voids inside, to become hydrophobic on the flat surface due to the introduction of micro-scale and nano-scale hierarchical roughness. Chemical vapor silanization also causes water to easily roll off giving the coating a persistent ability to repel water enabling the coating to spontaneously float on the water-air interface and not sink as well as maintain high water evaporation conversion efficiency.

Another embodiment of the claimed invention is directed to a method for water purification wherein dirty water or saline water may undergo evaporation and recondensation by receiving thermal energy from the interfacial solar membrane to evaporate the dirty water or saline water and condensing the evaporated dirty water or saline water when as the vapors are cooled, yielding clean water. In certain embodiments, the method may be used to produce drinkable water, agricultural water, water for petroleum, and other industries. The method may also be used for drinking water purification, seawater desalination, and wastewater treatment. In wastewater treatment, for example the treatment of urine, the salts left after water evaporation can be used as fertilizers for agriculture. In other embodiments, the method may be used for in-situ heating pipes and panels. The method may also be utilized in a portable water purification device. In other further embodiments, the method may be utilized by other systems that require localized heating.

### WORKING EXAMPLES

A versatile thin film dip-coating fabrication strategy for polypyrrole (PPy)-coated interfacial solar membrane based on traditional thermal desalination membrane material, such as a porous polypropylene substrate, which has been widely used as thermal desalination membrane for decades. Polypyrrole (PPy) was selected as the thin film coating on the non-conductive polypropylene due to its broad spectrum absorption (from visible to near-infrared) and high photothermal conversion efficiency. PPy has outstanding stability and is cost-effective compared with noble metal nanoparticles. PPy also has good biocompatibility and low long-term cytotoxicity in comparison of carbon material. PPy is also known to have a self-healing hydrophobicity (wettability) property to maintain hydrophobicity and the hydrophobic fluoroalkylsilane top layer of the coating. This property is attributed to self-migration of fluoroalkylsilane within the PPy coating under chemical oxidation (oxidative chemical from water and air, strong radiation from UV light) and maintains the solar vapor generation efficiency by floating the interfacial solar membrane on a water-air interface.

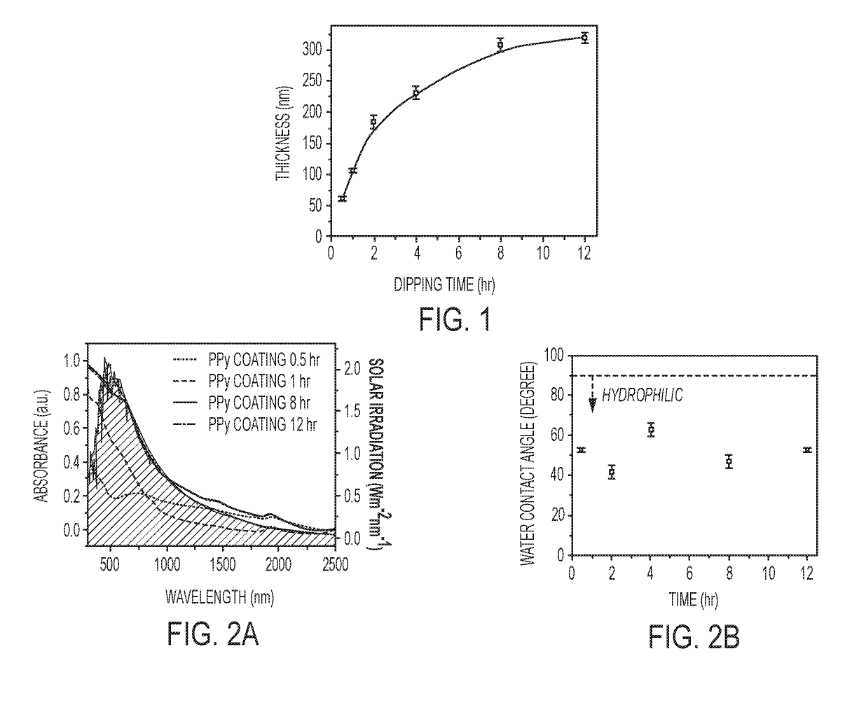

The fluoroalkylsilane surface layer of the PPy coating was prepared with the expectation of maintaining a long-term hydrophobicity. Instead of utilizing electroplating, which can only coat on the conductive substrate, a thin film dip-coating method was utilized. A substrate (in this experiment, polypropylene), was immersed in a mixture of dilute aqueous pyrrole monomers and FeCl₃, which functions as an oxidant. The mixture then initiated direct polymerization on the surface and tightly bonded on the substrate surface to form a smooth coating on different substrates, regardless of initial wetting property, electric conductivity, and curvature of substrates. Substrates tested included hydrophilic glass and a hydrophobic polypropylene plastic centrifuge tube. In comparison, electrochemical polymerization of PPy, which has been reported and used as interfacial solar membrane, requires the coating substrate to conduct electricity. By increasing a reaction time, a thickness of PPy coating increased from ˜50 nm to ˜300 nm (e.g., see FIG. 1). Correspondingly, an intensity of dark color increases with extended dipping time. Three regions were observed. The first region is a nearly constant region that was due to the slow incubation for the deposition in solutions with low oxidant (FeCl₃)/pyrrole ratios. The second region is expected to rise linearly with time. In the third region, a rate of growth slows down. This decrease in the deposition rate can be explained by the depletion of the reactants in the solution and ends with ceasing to increase the thickness of the coating.

Compared to methods of previous disclosures (electrochemical polymerization), the instant dipping methods lead to a controllable nanometer thickness as well as allowing coatings on non-conductive curved surfaces, such as PP mesh and conductive curved surfaces such as a stainless steel mesh, to be easily formed. Scanning electron microscope images of a treated fiber mesh showed that PPy uniformly coated each PP fiber in the mesh. At high magnification it was seen that the uniform PPy coatings are porous and made of compacted PPy nanoparticles (˜50 nm). As illustrated in the graph of FIG. 2A, the thin PPy coating exhibits a broad absorption band with a wide range of light from UV to visible light and near infra-red which matches the spectrum of sunlight (gray shadowed region). The absorbance increases with an increase in the thickness of the PPy coating. The absorbance saturates around a coating thickness of ˜300 nm (8 hour) PPy. Increasing the thickness beyond 8 hours (from 8 to 12) does not help to harvest more solar energy trapped in a PPy membrane.

Surface wetting was identified as another important parameter. Surface wetting influences interfacial solar membrane performance. The interfacial solar membrane should be floating on water during water evaporation. A hydrophobic surface with a high propensity of water droplets to roll off the surface is the desired outcome, which depends not only on a chemical nature but also on a hierarchical structure of the surface. As shown in FIG. 2B, the deposited PPy coating is hydrophilic and has a contact angle of nearly 60° on the flat surface. The hydrophobicity of the PPy coating remains the same with the increase in coating thickness from ˜50 nm to ˜200 nm. To tune the wettability from hydrophilic to hydrophobic, chemical vapor silanization of fluoroalkylsilane was chosen to uniformly penetrate through the coating, including both the surface layer and the polymer and voids inside. After chemical vapor silanization, the PPy coating became hydrophobic on the flat surface and good hydrophobicity as well as an excellent propensity for water droplets to roll off were both observed on the PP mesh. This was due to the introduction of micro-scale and nano-scale hierarchical roughness. The water droplet rolled off from its centimeter sized squared mesh surface easily within 0.1 seconds while a water droplet of the same volume becomes pinned on top of the unmodified PP mesh. The modified PP mesh has a much better propensity to allow water droplets to roll off than the PP mesh itself. The propensity of water droplets to roll off is also maintained when depositing the same coating on a stainless steel mesh. This property also helped enable the modified PP mesh to spontaneously float on the water-air interface and prevent it from sinking into water, maintaining high solar vapor generation efficiency.

The hydrophobicity and excellent water repellency ensures that the PPy coated PP mesh floats on water without sinking into the water. It also ensures the pores of the PPy-coated mesh are unblocked with the continuous optimized flow flux of water vapor. The photothermal property of the PPy-coated PP mesh was evaluated by in-situ temperature mapping using an IR camera and under solar radiation with the light intensity of 1000 W/m². Under solar irradiation, the temperature of PPy coated PP mesh increased gradually and reached an equilibrium temperature of ˜50° C. after ˜600 seconds. When shut down, with the solar irradiation to dark, it takes another ˜600 seconds to recover back to 22° C., which is slightly higher than room temperature. In comparison, the PP mesh without PPy coating keeps at room temperature (20° C.) under 20 minutes' solar irradiation without increasing in temperature. It clearly demonstrated the efficient light-to-heat conversion property of PPy coated PP mesh due to the contribution of ˜300 nm PPy coating on the PP mesh. Due to the low thermal conductivity and low specific heat capacity of PPy and PP material, it forms a heat barrier in order to enhance the heat localization.

The performance of enhanced water evaporation is then conducted by floating a hydrophobic PPy coated PP mesh at water-air interface inside the beaker. Due to the hydrophobicity, the PPy coated PP mesh stays at the water-air interface spontaneously. Simulated sunlight radiates under the light intensity of 1000 W/m². The mass loss of water during water evaporation was monitored by analytical balance. As a control, a mass loss of water with the floating PP mesh at the air-water interface and a mass loss of water in the absence of mesh on the water were also measured. The seawater evaporation follows the same trend. Using PPy coated PP mesh increases the seawater evaporation rate. The solar vapor generation efficiency is defined as a ratio of enthalpy change in the generated vapor divided by the total incoming solar flux, which is evaluated based on water evaporation rate and given by Equation 1:

η=Q(water evaporation)/Q_{Light}=(water evaporation rate×Hₑ)/Q_{Light} Equation (1)

where Q_{Light} is the incidence light intensity (1000 W/m²), Hₑ is the heat of evaporation of water (2260 KJ/Kg). As calculated, the solar vapor generation efficiency of PPy-coated PP mesh is higher than using PP mesh or pure solution for both water and seawater evaporation. The PPy coated PP mesh has a solar vapor generation efficiency of 72%, which is slightly higher than stainless steel mesh with PPy coatings of micrometer thickness and much higher than that of commercialized solar stills with typical efficiencies of 24%-45%. The improvement over commercialized solar stills is due to efficient solar energy harvesting from the contribution of ˜300 nm PPy coating and the heat barrier property of the bulk PPy coated PP mesh that result from a low thermal conductivity and a low specific heat capacity of both PPy coating and PP mesh. Moreover, the PPy thin film coating is robust under mild shaking in water and seawater (35,000 ppm NaCl). It is stable when floating on or immersed in water or seawater with mild shaking for 7 days. Fourier-transform infrared spectroscopy (FTIR) spectra of the selected solutions did not show any characteristic peaks from PPy or possible decomposed structure, indicating no detachment and release of the PPy coating as well as no decomposition of the PPy coating.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. Additionally, components from one embodiment may be interchanged with similar components from another embodiment. It is intended that the Specification and examples be considered as illustrative only.

What is claimed is:

1. A method of producing an interfacial solar membrane comprising:
dipping a substrate into a solution of pyrrole monomer and iron(III) chloride; and
forming a polypyrrole coating on the substrate via in-situ polymerization.

2. The method of claim 1, wherein the substrate comprises a polypropylene mesh.

3. The method of claim 1, wherein the polypyrrole coating comprises a thickness of less than or equal to 300 nm.

4. The method of claim 1, further comprising:
applying a second coating to the interfacial solar membrane via chemical vapor silanization of 1H,1H,2H-perfluorooctyltriethoxysilane to tune a wetability of the interfacial solar membrane; and
wherein the second coating causes the interfacial solar membrane to become hydrophobic.

5. The method of claim 4, wherein the chemical vapor silanization introduces micro-scale and nano-scale hierarchical roughness to cause the hydrophobicity.

6. The method of claim 1, wherein the substrate comprises at least one of a metal, a polymer, and a ceramic.

7. The method of claim 1, wherein the substrate is non-conductive.

8. The method of claim 1, wherein the substrate is conductive.

9. An interfacial solar membrane comprising:
a substrate;
a coating of polypyrrole disposed on a surface of the substrate; and
wherein the coating of polypyrrole is formed by dipping the substrate in a solution of pyrrole monomer and iron(III) chloride.

10. The interfacial solar membrane of claim 9, further comprising a coating of 1H,1H,2H-perfluorooctyltriethoxysilane disposed over the coating of polypyrrole.

11. The interfacial solar membrane of claim 9, wherein the substrate comprises a polypropylene mesh.

12. The interfacial solar membrane of claim 9, wherein the substrate comprises at least one of a metal, a polymer, and a ceramic.

13. The interfacial solar membrane of claim 9, wherein the substrate is comprised of stainless steel.

14. The interfacial solar membrane of claim 9, wherein the coating of polypyrrole comprises a thickness of less than or equal to 300 nm.

15. The interfacial solar membrane of claim 9, wherein the substrate is non-conductive.

16. The interfacial solar membrane of claim 9, wherein the substrate is conductive.

17. A method for water purification, the method comprising:
using the interfacial solar membrane of claim 9 to evaporate a fluid;
condensing the evaporated fluid to provide a treated fluid.

18. The method of claim 17, wherein:
the fluid is water containing an impurity; and
the treated fluid comprises the water with the at least some of the impurity removed.

19. The method of claim 17, wherein:
the fluid is saline water; and
the treated fluid comprises the saline water with at least some of the saline removed.

20. The method of claim 17, wherein:
the fluid is wastewater such as urine; and
after water evaporation, the substrates left can be used as fertilizers for agriculture.
